(19) United States
(12) Patent Application Publication
(10) Pub. No.: US 2026/0087040 A1
(43) Pub. Date: Mar. 26, 2026

(54) POSITION ESTIMATION OF AN ANATOMICAL LANDMARK BY TEXT INPUTS

(71) Applicant: Siemens Healthineers AG, Forchheim (DE)

(72) Inventors: Mohammad Abdishektaei, Charlottesville, VA (US); Halid Yerebakan, Carmel (IS); Gerardo Hermosillo Valadez, West Chester, PA (US)

(21) Appl. No.: 19/303,502

(22) Filed: Aug. 19, 2025

(30) Foreign Application Priority Data
Sep. 25, 2024 (DE) 10 2024 127 852.8

(51) Int. Cl. G06F 16/3329; G06F 40/205

(52) U.S. Cl. CPC G06F 16/33295; G06F 40/205

(57) ABSTRACT

Training framework for creating an artificial intelligence (AI) system for estimating a position of an anatomical landmark by text inputs. The training framework includes providing a context-set comprising a list of names of anatomical landmarks, and a position-list comprising position-tokens being expressions referring to relative positions. A plurality of question-prompts asking for the relative position of a landmark are generated by using varying combinations of the landmarks and position-tokens of the context-set and the position-list. A number of target-landmarks to each question-prompt are generated by inputting the question-prompts in a large language model. The answer is parsed for landmarks and the found landmarks are defined as target-landmarks. A plurality of training-datasets are formed, wherein each training-dataset comprises the landmark, the position-token from a question-prompt and the target-landmark from the answer to this question-prompt. The AI-system is trained with the training-dataset and additional spatial coordinates of a part of the landmarks of the context-set.

### CROSS-REFERENCE TO RELATED APPLICATION

This application claims the benefit of priority from German Patent Application No. 102024127852, filed on September 25, 2024, the contents of which are incorporated by reference.

### TECHNICAL FIELD

The present framework relates to estimating a position of an anatomical landmark by text inputs.

### BACKGROUND

The human body is a complex organism comprising various elements like bones, organs, vessels and other parts. Even for a medical expert, it is difficult to spot every single part of the human body. There does not appear to exist a list of the coordinates of the elements of the body that can be separated from other elements.

Although there are large language models with a basic understanding of human anatomy, the absolute coordinates of the landmarks may not be inferred directly from these models. In addition, these models are generally large in size and require expensive computation hardware to run.

### SUMMARY

A training framework for creating an artificial intelligence (AI) system for estimating a position of an anatomical landmark by text inputs is described herein. The training framework includes providing a context-set comprising a list of names of anatomical landmarks, and a position-list comprising position-tokens being expressions referring to relative positions. A plurality of question-prompts asking for the relative position of a landmark are generated by using varying combinations of the landmarks and position-tokens of the context-set and the position-list. A number of target-landmarks to each question-prompt are generated by inputting the question-prompts in a large language model. The answer is parsed for landmarks and the found landmarks are defined as target-landmarks. A plurality of training-datasets are formed, wherein each training-dataset comprises the landmark, the position-token from a question-prompt and the target-landmark from the answer to this question-prompt. The AI-system is trained with the training-dataset and additional spatial coordinates of a part of the landmarks of the context-set.

### BRIEF DESCRIPTION OF THE DRAWINGS

FIG. 1 shows a human body with a coordinate system and a certain landmark;

FIG. 2 shows a first part of an exemplary training device;

FIG. 3 shows a second part of an exemplary training device as well as an exemplary artificial intelligence (AI) system;

FIG. 4 shows an exemplary training device; and

FIG. 5 shows a block diagram of an exemplary training method.

### DETAILED DESCRIPTION

One aspect of the present framework pertains to an artificial intelligence (AI)-system for estimating a position of an anatomical landmark by text inputs. It describes a training method for creating such AI-system, the AI-system and a training device for training this AI-system. It is the object of the present framework to improve known systems and methods and provide a training method for creating an AI-system for estimating a position of an anatomical landmark by text inputs, a small-scale AI-system for estimating a position of an anatomical landmark by text inputs and a training device for training an AI-system for estimating a position of an anatomical landmark by text inputs, for overcoming the above described problems. It is especially an object of the present framework to provide a methodology to build a language model that understands human anatomy and that can estimate the position of a huge number of anatomical landmarks.

A training method according to the framework serves for creating an AI-system for estimating a position of an anatomical landmark by text inputs. It comprises the following steps:

providing a context-set comprising a list of names of anatomical landmarks,

providing a position-list comprising position-tokens being expressions referring to relative positioning,

generating a plurality of question-prompts asking for the relative position of a landmark, by using varying combinations of the landmarks and position-tokens of the context-set and the position-list,

generating a number of target-landmarks to each question-prompt by inputting the question-prompts in a large language model with a basic understanding of human anatomy to obtain an answer, parsing the answer for landmarks and defining the found landmarks as target-landmarks,

forming a plurality of training-datasets, wherein each training-dataset comprises the landmark, the position-token from a question-prompt and the target-landmark from the answer to this question-prompt,

training the AI-system with the training-dataset and additional spatial coordinates of a part of the landmarks of the context-set.

An element of a body (e.g., human, animal) is addressed with the expression “landmark”. Like a point of interest of a map, a landmark is a point of interest in the body. A landmark may e.g., be a special bone, an organ or a part of a vessel like the aorta. A landmark may refer to a complete organ, e.g., the heart, or a part of an organ. e.g., the left ventricle.

The position of a landmark may be given by the position of a point of this landmark, e.g., the center point. However, since the training is based on public information, the “anchor point” for a position of a landmark may be different over the given information or may have a statistical error. On the other side, a landmark has a certain volume and it may be spotted even in the case the information about the position is a little blurred. Thus, the determined position (possibly averaged) may be interpreted as the position of a predefined point of the respective landmark, e.g., its center point.

The training method uses known relative positions of variety of anatomical landmarks and may provide absolute positions for a vast number of landmarks even when only the absolute positions of a few landmarks are known. This is achieved with the special training procedure according to some implementations. This training method uses a large language model (LLM) that knows relative positions of landmarks to each other. A relative position is, for example, given by the information “the sternum lies 10 cm inferior to the heart”.

A vast amount of relative positions of landmarks may be used in order to determine (absolute) positions of these landmarks. In theory, absolute positions may be triangulated by knowing the absolute position of a first landmark and the relative position of a second landmark to this first landmarks. However in reality, the given relative positions are often vague and also may refer to one single axis in space, only, e.g., as in the example above “the sternum lies 10 cm inferior to the heart”.

An AI model may be trained such that a landmark may be inputted and the AI-system provides the position of this landmark in a body. Concerning the human body, there may be a model-body where the absolute positions of the landmarks may be provided. This model may be rendered as graphical image or be purely theoretical.

In one implementation, the training method comprises several steps:

First, a context-set and a position-list are provided. The context-set comprises a list of names of anatomical landmarks, e.g., “heart”, “left foot”, “brain”, but e.g., also “left ventricle”, “aorta”, “distal ring phalanx”. The context-set may be present in a memory, maybe on a non-transitory memory device. The names of the landmarks known by the method are the context-set. It should be noted that the context set is the plurality of all landmarks from which information is available. When new landmarks are added, the context-set grows. The “initial context-set” is the context-set at the beginning of the procedure without newly learned landmarks.

The position-list comprises position-tokens being expressions referring to relative positioning. The values of distances may be separate distance-tokens of the position-list that may be combined with the position-tokens or the position-tokens may already comprise distances. Examples for position-tokens are “inferior to the”, “posterior to the” or also with given distances “10 cm above the”, “5 mm distal to the” or “about 25 cm left of the”. The position-tokens should preferably be designed such that combined with the landmarks and together with an introduction like “What landmark lies” they may form a complete question. However, each position-token may already comprise an introducing passage and may read “What landmark lies 7 cm proximal to”.

With changing variations of the position-tokens (maybe together with distance-tokens) and landmarks, a plurality of question-prompts are generated. There may be used additional introducing passages like “What landmark lies” or “What landmark is positioned”. The question-prompt is designed such that the name of a landmark (this is the “target-landmark”) is a possible answer. Here it should be recognized that “I don’t know” or “none” may also be a valid answer. How to produce questions from given words is well known in the art. The question-prompts may all sound similar witch changing position-tokens (also with changing distances) and changing landmarks.

The question-prompts are then inputted into a large language model (LLM) with a basic understanding of human anatomy. This LLM then produces an answer. By using an LLM, a vast number of questions may be answered in short time and a vast number of training-datasets may be produced.

Since the questions are designed such that landmarks are possible answers, a number of target-landmarks may be generated to each question-prompt by the LLM. Since the answer may comprise other words that are no landmarks, e.g., like “The answer is:” or “there are several landmarks, like”, or since there may be mentioned several landmarks in the answer, the answer is parsed for landmarks. Each found landmark is then defined as “target-landmark”. Unknown target-landmarks may be added to the context-set, e.g., by adding them to the memory.

Based on the question-prompt and the answer to this question-prompt a training-dataset is formed by combining a landmark, a position-token from the question-prompt and a target-landmark from the answer. Since there are many question-prompts, many training-datasets may be generated.

For example, the question to the LLM is “What target-landmark lies 10 cm inferior to the heart” and the answer of the LLM is “aorta, sternum, left ventricle etc.”. Then, this list is used to construct the training-datasets by parsing this list and declaring “aorta”, “sternum” and “left ventricle” as target-landmarks. The expression “etc.” is recognized as not being a landmark and ignored. The training-datasets then be: “Heart, 10 cm inferior, aorta”, “Heart, 10 cm inferior, sternum”, “Heart, 10 cm inferior, left ventricle”, with the order “landmark”, “position-token”, “target-landmark”.

The training-datasets are then used for training the AI-system. Here it should be noted that the AI-system is designed for estimating a position of an anatomical landmark by text inputs. Thus, the AI-system is trained to arrange the target-landmark in a coordinate system, wherein the arrangement results in a position of this landmark. How this may be achieved in an advantageous manner is explained further below.

In short: the core of the training method is to generate question-prompts, ask an LLM with a basic understanding of human anatomy and use its answer together with the question-prompts to generate training-datasets and train the AI-system.

Since there are only known spatial coordinates of some of the landmarks, the AI-system is designed such that it generates a vector in an embedding space, an “embedding vector”, for an inputted landmark. For that, a part of the AI-system is trained with the training-dataset only (e.g., without any absolute coordinates). Since each training-dataset pertains to a relative position of a landmark to a target landmark, the embedding vector may reflect learned relative positions of a target-landmark to many other landmarks in the embedding space. The training is formulated to leverage relative position of the landmark to achieve that goal. Since the embedding vector is an output of a machine learning network, it may be an abstract thing.

Now, this embedding vector may be processed by another part of the AI-system (e.g., the E2C-model explained further below) in order to extract a physical position out of this embedding vector. For that, the spatial coordinates may be used. For example, when it is known that a target-landmark lies 10 cm right to the liver and 7 cm below the heart, its position may be triangulated. Although here the issue is more complex it may be easily understood by using the above “map” again. In this map there are also landmarks from that the absolute positions are known. Thus, the map may be registered onto these known coordinates (image registration is well known). This registration may move the target-landmark of interest onto one position. The coordinate of this position may then be assumed to be the absolute coordinate of the target-landmark of interest.

However, since the embedding vector is an abstract thing, it may be easier to train a unit of the AI-system to convert the embedding vector of a target-landmark to a spatial coordinate. This may be done by inputting the embedding vectors of landmarks with known spatial coordinates and their coordinates as training data, wherein the known coordinates serve as ground truth.

An AI-system according to one implementation estimates a position of an anatomical landmark by text inputs. It is trained by the training method according to some implementations. The AI-system preferably comprises a target-encoder combined with an embed to control (E2C)-unit in that the output of the target-encoder is the input of the E2C-unit and the E2C-unit is adapted to output a spatial coordinate from an inputted embedding vector of the target-encoder. This network is trained with a training method concerning spatial coordinates known for a part of the landmarks of the context-set.

A training device serves to train an AI-system for estimating a position of an anatomical landmark by text inputs with a training method. The training device comprises the following components:

a landmark-encoder designed to map an inputted landmark to an embedding space,

a position-encoder designed to map an inputted position-token to an embedding space,

a target-encoder designed to map an inputted target-landmark to an embedding vector,

a predictor-unit designed to map the outputs of the landmark-encoder and the position-encoder to an embedding vector

a first loss unit, designed to compare inputted embedding vectors,

an E2C-unit designed to map an inputted embedding vector to spatial coordinates, and

a second loss unit designed to compare inputted coordinates.

The training device is preferably designed for performing the training method according to some implementations.

The training device comprises a landmark-encoder, a position-encoder, a target-encoder, a predictor-unit, a first loss-unit, an E2C-unit and a second loss-unit. It may enable a two-phase-training of the AI-system that comprises the trained target-encoder together with the trained E2C-unit as described above. The first training phase may train the target-encoder to generate an embedding vector for an inputted landmark. This training may be achieved with the training-datasets and the landmark-encoder, the position-encoder, the target-encoder, the predictor-unit and the first loss-unit. The second phase of training may use landmarks (with known absolute coordinates) as input for the trained target-encoder in order to train the E2C-unit, wherein the known coordinates of the landmarks are used as ground truth acting with the second loss function.

The landmark-encoder is designed to map an inputted landmark to an embedding space. It may be pre-trained or being trained during the training procedure.

The position-encoder is designed to map an inputted position-token to an embedding space. It may be pre-trained or being trained during the training procedure.

The target-encoder is designed to map an inputted target-landmark to an embedding vector. Embedding vectors generated from the target-encoder are later used as inputs for the E2C-unit. The target-encoder may be pre-trained, but is necessarily trained by the training method according to some implementations.

The predictor-unit is designed to map the outputs of the landmark-encoder and the position-encoder to an embedding vector. It may be pre-trained or being trained during the training procedure. While the landmark-encoder and the position-encoder just convert the landmarks and position-tokens into a certain space, in order that the predictor-unit may “understand” this input, it must convert this input into the embedding vector comprising information about the relative coordinates of a target-landmark to (the) other landmarks.

The first loss-unit is designed to compare embedding vectors inputted from the predictor-unit on the one hand and the target-encoder on the other hand. While the predictor-unit receives information about a target and position-token of a question-prompt, the target-encoder receives the target-landmark from the answer of this question prompt and tries to produce an embedding vector. The part of the embedding vector of the target-encoder relating to the embedding vector of the predictor unit may be compared by the first loss-unit. For a simple understanding, it should be noted that for one single training-dataset, the predictor-unit only outputs an embedding vector saying something like “10 cm below the heart”, not knowing anything about the target-landmark (since it is inputted into the target-encoder). The target-encoder on the other side is trained to process the inputted target-landmark in order to get it into distance relation to as many other landmarks as possible. Thus, the embedding vector for the target-landmark “sternum” may comprise information about the distances to many other landmarks and one information may possibly be something like “7 cm below the heart”. Now, the first loss-function is adapted to find the correct entry of the embedding vector of the target-encoder and to compare it with the matching embedding vector of the predictor-unit. Then, the weights of the target-encoder may be adjusted in that the target encoder may possibly output an information such as “10 cm below the heart” when the “sternum” may again be inputted as target-landmark. Trained with a great number of training-datasets, the target-encoder may output an embedding vector including information about relative coordinates to many landmarks.

In some implementations, all components are trained. In the course of training, the weights of the landmark-encoder and position-encoder in addition to the weights of the predictor-unit are updated using backpropagation methods. The weights of the target-encoder are updated using moving average of the context- and position-encoders.

As already said above, the E2C-unit is designed to map an inputted embedding vector to spatial coordinates.

The second loss-unit is designed to compare inputted coordinates. Here landmarks of the context-set with known coordinates are input into the (trained) target-encoder, only. The output of the target-encoder (an embedding vector) is then inputted into the E2C-unit that is trained to generate coordinates. These generated coordinates are then compared with the known coordinates by the loss function and the weights of the E2C-unit are adjusted accordingly.

Besides the special training-datasets that are used, the present framework especially pertains to the special architecture and the two-phase training of the training device. Some units or modules mentioned above can be completely or partially realized as software modules running on a processor of a computing system. A realization largely in the form of software modules can have the advantage that applications already installed on an existing computing system can be updated, with relatively little effort, to install and run these units of the present application. The object of the invention is also achieved by a computer program product with a computer program or computer-readable program code that is directly loadable into the non-transitory memory device of a computer system, and which comprises program units to perform the steps of the methods, at least those steps that may be executed by a processor, when the program is executed by the computer system. In addition to the computer program, such a computer program product can also comprise further parts such as documentation and/or additional components, also hardware components such as a hardware key (dongle etc.) to facilitate access to the software.

One or more non-transitory computer readable media such as a memory stick, a hard-disk or other transportable or permanently-installed carrier can serve to transport and/or to store the instructions or executable parts of the computer program product so that these can be read from a processor unit of a computer system. A processor unit can comprise one or more microprocessors or their equivalents.

Particularly advantageous embodiments and features of the invention are given by the dependent claims, as revealed in the following description. Features of different claim categories may be combined as appropriate to give further embodiments not described herein.

According to an exemplary training method, the context-set comprises multiple landmarks of a human skeleton, joints, ligaments, muscles, tendons, mouth, salivary glands, pharynx, esophagus, stomach, small intestine, large intestine, rectum, liver, gallbladder, mesentery, pancreas, anal canal, nasal cavity, pharynx, larynx, trachea, bronchi, bronchioles and smaller air passages, lungs, muscles of breathing, kidneys, ureter, bladder, urethra, ovaries, fallopian tubes, uterus, cervix, placenta, vulva, vagina, testicles, epididymi-des, vasa deferentia, seminal vesicles, prostate, bulbourethral glands, penis, scrotum, pituitary gland, pineal gland, thyroid gland, parathyroid glands, adrenal glands, pancreas, heart, arteries, veins, capillaries, lymphatic vessel, lymph node, bone marrow, thymus, spleen, gut-associated lymphoid tissue, interstitium, brain, spinal cord, choroid plexus, nerves, eye, ear, olfactory epithelium, tongue, mammary glands, skin and subcutaneous tissue, or a combination thereof. In some implementations, the context-set comprises the names of the most common anatomical landmarks. From many landmarks listed above, the coordinates in a human body are known. They may be used for the second training-phase described above.

According to an exemplary training method, the position-list is preferably based on a coordinate system which includes orthogonal directions in sagittal, coronal, and transverse planes. This coordinate system is commonly used in medicine.

According to an exemplary training method, the position-list comprises words with an expression for a distance value, especially a number and a length unit, and an expression of a direction, especially multiple words of the group “superior”, “inferior”, “posterior”, “anterior”, “medial”, “distal”, “above”, “below”, “left” and “right”. Possible position-tokens may be “x mm superior to”, “y mm inferior to”, “z mm posterior to”.

In some implementations, the position-list comprises position-tokens without a distance value and a set of distance values that may be combined with the position-tokens. Possible distance values may be values like “1 cm”, “100 mm” or “0.4 m”. Units and values may also be separated and combined with each other in order to forma distance value. Distance values may be any integer or real values from 1 mm to 2 m; however, they should be chosen to fit into the body. An example for distance tokens may be “above the”, “below the”, “left from the”, “right from the” and distance values may read “1 cm”, “2 cm”, ..., “200 cm”, wherein a combination may read “5 cm left from the” or “50 cm above the”.

According to an exemplary training method, the question-prompts are generated by using a list of initiation phrases. This may be phrases like “What are the landmarks approximately” or “Please tell me what target lies” or “give me the position of the landmark lying”. This initiation phrase is then followed by the position-token, especially a varying set of a distance value and a position-token, then there may especially follow a number of filling words (like “the”), when not already being part of the distance token. Then, a landmark may be appended. Last, a question mark may be added. The result may read such like: “What are the landmarks approximately 10 cm below the heart?”.

According to an exemplary training method, the answer to each question-prompt is based on the context-set or wherein the answer to each question-prompt is parsed for new landmarks and the new landmarks are added to the context-set, and the respective landmark of the answer is the target-landmark. Here it should be noted that the answer may consist of many words. The target-landmark(s) have to be extracted from these words. This may simply be achieved by comparing the words with the landmarks of the context-set. However, there are other possibilities to recognize a landmark, e.g., when the answer consists of a single word being different from “None”. New landmarks may be added to the context-list in order to enhance the result.

According to an exemplary training method, in the course of (or during) a first training phase especially for training in a training device described above,

the landmark of the training-dataset is inputted into a landmark-encoder,

the position-token of the training-dataset is inputted into a position-encoder, and

the target-landmark of the training-dataset is inputted into a target-encoder,

wherein each encoder maps its input to an input embedding space.

The input embedding spaces of the landmark encoder and the position-encoder may be inputted into a predictor-unit designed to map its input to an estimated-embedding vector and wherein the target encoder is designed to map its input to a target-embedding vector and the loss between the estimated-embedding vector and the target-embedding vector are computed.

According to an exemplary training method, in the course of (or during) a second training phase the target-encoder is combined with a E2C-unit in that the output of the target encoder is the input of the E2C-unit and wherein the E2C unit is designed to map an inputted embedding vector to spatial coordinates, and wherein the output of the E2C unit and given coordinates are inputted into a loss unit. As already said above, the used training set may only comprise landmarks with known coordinates as well as their coordinates as ground truth.

The present method may be AI-based. Artificial intelligence (AI) is based on the principle of machine-based learning and is usually carried out with an adaptive algorithm that has been trained accordingly. The expression “machine learning” is often used for machine-based learning, which also includes the principle of “deep learning”.

The methods may also include elements of "cloud computing". In the technical field of "cloud computing", an information technology (IT) infrastructure is provided over a data-network, storage space or processing power and/or application software. The communication between the user and the "cloud" is achieved by means of data interfaces and/or data transmission protocols. In the context of "cloud computing", provision of data via a data channel (for example a data-network) to a "cloud" takes place. This "cloud" includes a (remote) computing system, e.g., a computer cluster that typically does not include the user's local machine. The cloud service may provide computing power as well as application software.

Other objects and features of the present invention will become apparent from the following detailed descriptions considered in conjunction with the accompanying drawings. It is to be understood, however, that the drawings are designed solely for the purposes of illustration and not as a definition of the limits of the invention.

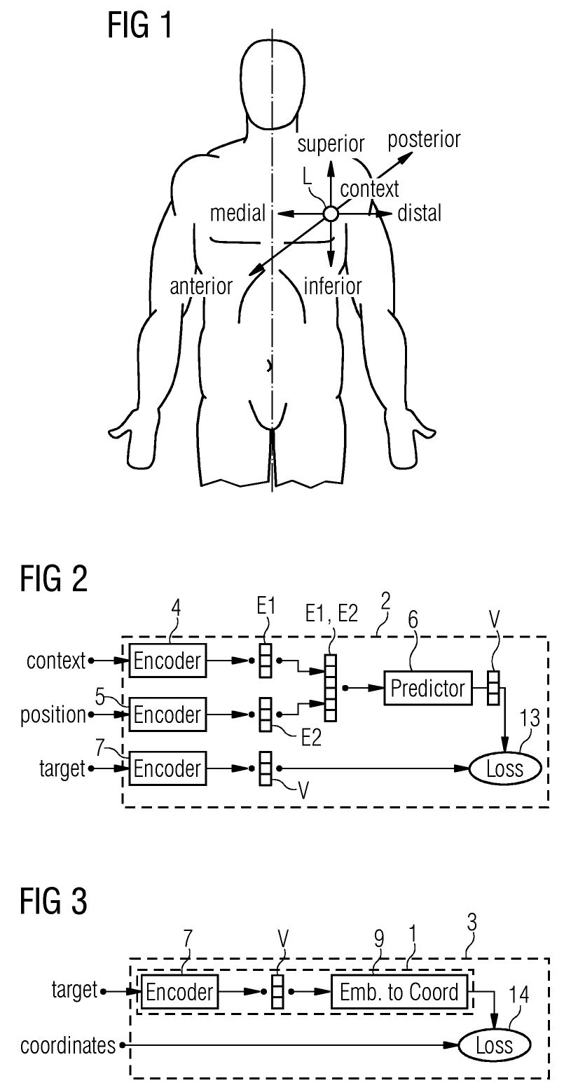

FIG. 1 shows a human body with a coordinate system and a certain landmark L. This landmark L may be a special bone, organ or muscle of the body as well as a special region of the skin. The coordinate system may comprise one axis pointing in superior / inferior direction (often also called Z-axis), one axis pointing in distal / medial direction (often also called X-axis) and one axis pointing in anterior / posterior direction (often also called Y-axis).

FIG. 2 shows a first part of an exemplary training device 10. This first part is a predictor network 2 comprising a landmark-encoder 4 designed to map an inputted landmark L to an embedding space E1, a position-encoder 5 designed to map an inputted position-token P to an embedding space E2, a target-encoder 7 designed to map an inputted target-landmark T to an embedding vector V, a predictor-unit 6 designed to map the outputs of the landmark-encoder L and the position-encoder 5 to an embedding vector V and a first loss-unit 13, designed to compare inputted embedding vectors V.

FIG. 3 shows a second part of an exemplary training device 10 s well as an exemplary AI-system 1. The second part of the training device 10 comprises the (trained) target-encoder 7 already shown in FIG. 2 during training, an E2C-unit 9 designed to map an inputted embedding vector V to spatial coordinates C, and a second loss-unit 14 designed to compare inputted coordinates C. The combination of target-encoder 7 with the E2C-unit 9 (when trained) is then an AI-system 1 according to some implementations.

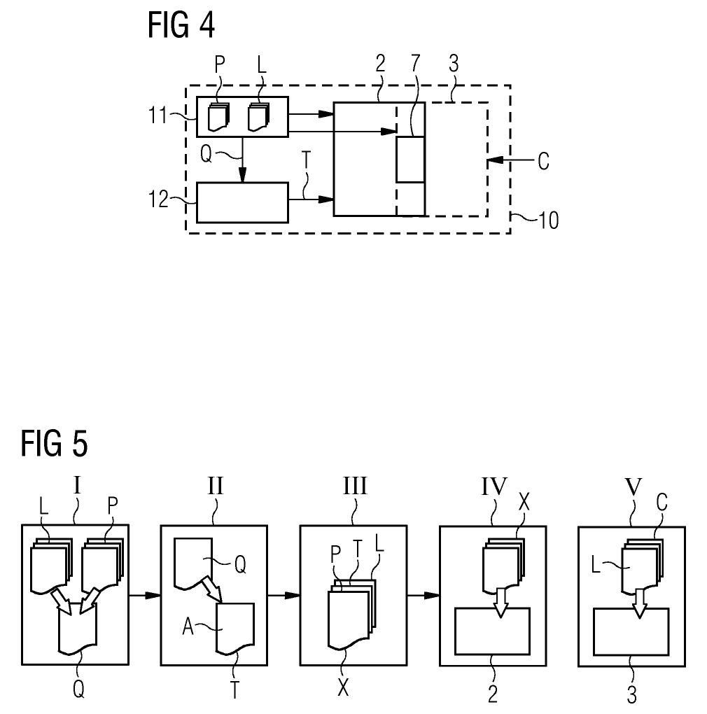

FIG. 4 shows an exemplary training device 10. At the left, there is a memory unit 11, where a context-set L and position list P may be stored and question-prompts Q may be generated. Furthermore, there is a large language model 12 that may produce target-landmarks T from the question-prompts Q by answering them. Landmarks L, position-tokens P and target-landmarks T are then inputted into the predictor-network 2 (see FIG. 2) and training its networks.

The target-encoder 7 trained by the predictor-network 2 is then used in an E2C-network 3 to train an E2C-unit (where target-encoder 7 and E2C-unit 9 readily trained may then be the AI-system 1). The training is done by using the landmarks L and known coordinates C of these landmarks L.

FIG. 5 shows an exemplary training method for creating an AI-system for estimating a position of an anatomical landmark by text inputs.

In step I, a context-set L is provided comprising a list of names of anatomical landmarks L, a position-list P is provided comprising position-tokens P being expressions referring to relative positioning and a plurality of question-prompts Q is generated by using varying combinations of the landmarks L and position-tokens P of the context-set L and the position-list P.

In step II, a number of target-landmarks T is generated for each question by inputting the question-prompts Q in a large language model with a basic understanding of human anatomy, parsing the answer A for landmarks L and defining the found landmarks L as target-landmark T.

In step III a plurality of training-datasets X is formed, wherein each training-dataset X comprises the landmark L, the position-token P and the target-landmark T of a question-prompt Q.

In step IV, a first training-phase is processed where the predictor-network 2 (see FIGS. 2 and 4) is trained. The goal is to train the target-encoder 7 of the predictor network 2. In this example, the weights of the landmark-encoder 4 and position-encoder 5 in addition to the weights of the predictor-unit 6 are updated using backpropagation methods. The weights of the target-encoder 7 are updated using moving average of the context- and position-encoders.

In step V, a second training-phase is processed where the E2C-network 3 (see FIGS. 3 and 4) is trained. The goal is to train the E2C-unit 9 with the trained target-encoder 7 with inputting landmarks L and coordinates C of these landmarks L.

Although the present invention has been disclosed in the form of preferred embodiments and variations thereon, it will be understood that numerous additional modifications and variations may be made thereto without departing from the scope of the invention. For the sake of clarity, it is to be understood that the use of "a" or "an" throughout this application does not exclude a plurality, and "comprising" does not exclude other steps or elements. The expression "a number of" means "at least one". The mention of a "unit" or a "device" does not preclude the use of more than one unit or device. Independent of the grammatical term usage, individuals with male, female or other gender identities are included within the term.

### LIST OF REFERENCE SIGNS

1 AI-system

2 predictor-network

3 E2C-network

4 context-encoder

5 position-encoder

6 predictor-unit

7 target-encoder

9 E2C-unit

10 training device

11 memory unit

12 large language model

13 first loss-unit

14 second loss-unit

A answer

E1, E2 embedding space

C coordinate

L landmark / context-set

P position-token / position-list

Q question-prompt

T target-landmark

V embedding vector

X training-dataset

The above examples are to be understood as illustrative examples of the invention. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A training method for creating an artificial intelligence (AI)-system for estimating a position of an anatomical landmark by text inputs, comprising:
providing a context-set comprising a list of names of anatomical landmarks; providing a position-list comprising position-tokens being expressions referring to relative positions;
generating a plurality of question-prompts asking for a relative position of a landmark by using varying combinations of the anatomical landmarks and the position-tokens of the context-set and the position-list;
generating target-landmarks to each question-prompt by inputting the question-prompts in a large language model to obtain an answer, parsing the answer to find landmarks and defining the found landmarks as the target-landmarks;
forming a plurality of training-datasets, wherein each training-dataset comprises the landmark, a position-token from a question-prompt and a target-landmark from the answer to this question-prompt; and
training the AI-system with a training-dataset and additional spatial coordinates of a part of the anatomical landmarks of the context-set.

2. The training method according to claim 1, wherein the position-list is based on a coordinate system which includes orthogonal directions in sagittal, coronal, and transverse planes.

3. The training method according to claim 1, wherein the position-list comprises words with an expression for a distance value and an expression of a direction.

4. The training method according to claim 3, wherein the expression for the distance value comprises a number and a length unit.

5. The training method according to claim 3, wherein the expression of the direction comprises superior, inferior, posterior, anterior, medial, distal, left and right, or a combination thereof.

6. The training method according to claim 1, wherein the position-list comprises position-tokens without a distance value and a set of distance values combinable with the position-tokens.

7. The training method according to claim 1, wherein the question-prompts are generated by using a list of initiation phrases followed by a position-token.

8. The training method according to claim 1, wherein the question-prompts are generated by using a list of initiation phrases followed by a varying set of a distance value and a position-token.

9. The training method according to claim 1, wherein the answer to each question-prompt is based on the context-set.

10. The training method according to claim 1, wherein the respective landmark of the answer is the target-landmark.

11. The training method according to claim 1, wherein the answer to each question-prompt is parsed for new landmarks and the new landmarks are added to the context-set.

12. The training method according to claim 1, wherein during a first training phase
the landmark of the training-dataset is inputted into a landmark-encoder,
the position-token of the training-dataset is inputted into a position-encoder, and the target-landmark of the training-dataset is inputted into a target-encoder.

13. The training method according to claim 12, wherein the landmark-encoder, position-encoder and the target-encoder map their input to input embedding spaces.

14. The training method according to claim 13, wherein the input embedding spaces of the landmark-encoder and the position-encoder are inputted into a predictor-unit that maps its input to an estimated-embedding vector.

15. The training method according to claim 14, wherein the target-encoder maps its input to a target-embedding vector and a loss between the estimated-embedding vector and the target-embedding vector is computed.

16. The training method according to claim 12, wherein during a second training phase the target-encoder is combined with an embed to control (E2C)-unit in that an output of the target-encoder is an input of the E2C-unit and wherein the E2C-unit maps an inputted embedding vector to spatial coordinates, and wherein the output of the E2C-unit and spatial coordinates are inputted into a loss unit.

17. A computer system for estimating a position of an anatomical landmark by text inputs, comprising:
a non-transitory memory device for storing computer readable program code; and
a processor in communication with the non-transitory memory device, the processor being operative with the computer readable program code to create an artificial intelligence (AI)-system by performing steps including
providing a context-set comprising a list of names of anatomical landmarks, providing a position-list comprising position-tokens being expressions referring to relative positions,
generating a plurality of question-prompts asking for a relative position of a landmark by using varying combinations of the anatomical landmarks and the position-tokens of the context-set and the position-list,
generating target-landmarks to each question-prompt by inputting the question-prompts in a large language model to obtain an answer, parsing the answer to find landmarks and defining the found landmarks as the target-landmarks,
forming a plurality of training-datasets, wherein each training-dataset comprises the landmark, a position-token from a question-prompt and a target- landmark from the answer to this question-prompt, and
training the AI-system with a training-dataset and additional spatial coordinates of a part of the anatomical landmarks of the context-set.

18. The computer system of claim 17, wherein the AI-system comprises a target-encoder combined with an embed to control (E2C)-unit in that an output of the target-encoder is an input of the E2C-unit and the E2C-unit is adapted to output a spatial coordinate from an inputted embedding vector of the target-encoder.

19. The computer system of claim 17, further comprises:
a landmark-encoder that maps an inputted landmark to an embedding space;
a position-encoder that maps an inputted position-token to an embedding space;
a target-encoder that maps an inputted target-landmark to an embedding vector;
a predictor-unit that maps outputs of the landmark-encoder and the position-encoder to an embedding vector;
a first loss-unit, that compares inputted embedding vectors;
an E2C unit that maps an inputted embedding vector to spatial coordinates; and
a second loss-unit that compares inputted coordinates.

20. One or more non-transitory computer-readable media embodying instructions executable by machine to perform steps for creating an artificial intelligence (AI)-system for estimating a position of an anatomical landmark by text inputs, comprising: providing a context-set comprising a list of names of anatomical landmarks; providing a position-list comprising position-tokens being expressions referring to relative positions;
generating a plurality of question-prompts asking for a relative position of a landmark by using varying combinations of the anatomical landmarks and the position-tokens of the context-set and the position-list;
generating target-landmarks to each question-prompt by inputting the question-prompts in a large language model to obtain an answer, parsing the answer to find landmarks and defining the found landmarks as the target-landmarks;
forming a plurality of training-datasets, wherein each training-dataset comprises the landmark, a position-token from a question-prompt and a target-landmark from the answer to this question-prompt; and
training the AI-system with a training-dataset and additional spatial coordinates of a part of the anatomical landmarks of the context-set.
